(19) United States
(12) Patent Application Publication
(10) Pub. No.: US 2026/0147012 A1
(43) Pub. Date: May 28, 2026

(54) OPERATION RECOGNITION DEVICE, AND OPERATION RECOGNITION METHOD

(71) Applicant: TOYOTA JIDOSHA KABUSHIKI KAISHA, Toyota-shi (JP)

(72) Inventor: Tomohiro TSUBOTA, Nagoya-shi (JP)

(73) Assignee: TOYOTA JIDOSHA KABUSHIKI KAISHA, Toyota-shi (JP)

(21) Appl. No.: 19/357,246

(22) Filed: Oct. 14, 2025

(30) Foreign Application Priority Data
Nov. 27, 2024 (JP) 2024-206000

(51) Int. Cl. G01P 13/00; G06V 10/70; G06V 20/52; G06V 40/10

(52) U.S. Cl. CPC G01P 13/00; G06V 10/70; G06V 20/52; G06V 40/10

(57) ABSTRACT

A operation recognition device recognizing work of a worker, comprises: an acquisition unit acquiring observation information obtained by observing a target operation with a sensor; and a operation identification unit identifying a type of the target operation using a prediction result from a first model and an estimation result from a second model, the first model being pre-trained on information related to an order in which a plurality of operations are performed and being configured to predict the type of the target operation as a next operation based on a type of a previous operation, the second model being pre-trained to estimate the type of the target operation based on the observation information.

### CROSS REFERENCE TO RELATED APPLICATIONS

The present application claims priority based on a Japanese patent application, application number 2024-206000, filed Nov. 27, 2024, the entire disclosure of which is incorporated herein by reference.

### BACKGROUND

### Field

This disclosure relates to an operation recognition device, and an operation recognition method.

### Related Art

Regarding an operation recognition device that recognizes a worker's operation, Japanese Patent Application Publication No. 2022-072444 discloses a technique for estimating a type of an operation appearing in an image or a skeletal sequence by inputting an image or skeletal sequence into an action recognition model.

However, for example, when performing operation recognition in a place such as a manufacturing site where an enormous variety of operations are carried out, using only information obtained by observing the operation through a sensor—such as an image or a skeletal sequence—as the basis for operation recognition may result in cases where the operation cannot be accurately recognized.

### SUMMARY

The present disclosure can be realized as the following form.

According to a first aspect of the present disclosure, an operation recognition device recognizing an operation of a worker is provided. The operation recognition device comprises: an acquisition unit acquiring observation information obtained by observing a target operation with a sensor; and an operation identification unit identifying a type of the target operation using a prediction result from a first model and an estimation result from a second model, the first model being pre-trained on information related to an order in which a plurality of operations are performed and being configured to predict the type of the target operation as a next operation based on a type of a previous operation, the second model being pre-trained to estimate the type of the target operation based on the observation information.

### BRIEF DESCRIPTION OF THE DRAWINGS

FIG. 1 is an explanatory diagram showing a schematic configuration of an operation recognition system;

FIG. 2 is a diagram illustrating the operation in a factory;

FIG. 3 is a conceptual diagram illustrating the flow of the operation recognition;

FIG. 4 is a diagram illustrating an operation identification process;

FIG. 5 is a flow chart showing processing steps of the operation recognition process.

### DETAILED DESCRIPTION

### A. First Embodiment

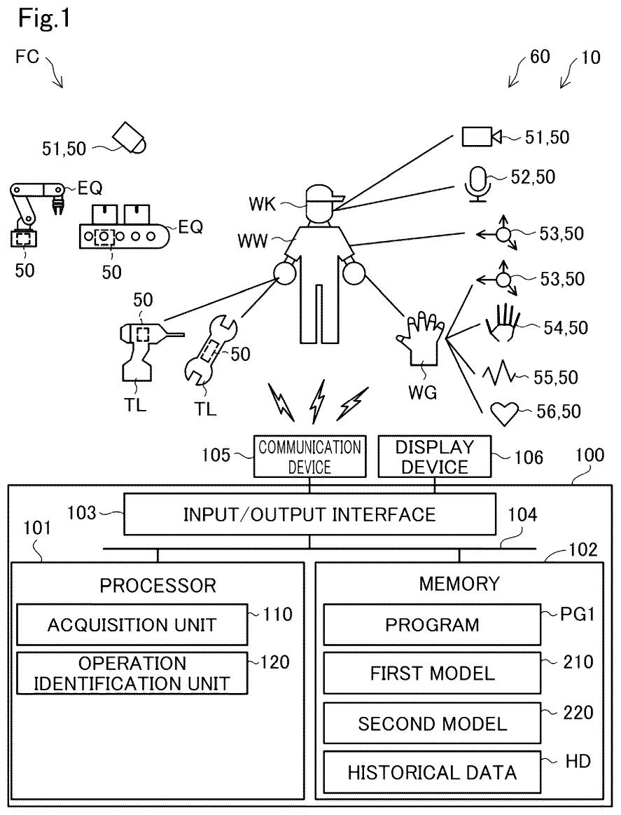

FIG. 1 is an explanatory diagram showing a schematic configuration of an operation recognition system 10 in the first embodiment. The operation recognition system 10 is used to recognize an operation performed by the worker WK. The operation to be recognized by the operation recognition system 10 is also called “target operation”. “Recognizing the target operation” more specifically means recognizing a type of the target operation.

The operation recognition system 10 is used in the workshop where the worker WK performs the work. The workshop in the present embodiment is a factory FC for manufacturing a vehicle. The operation in the present embodiment is an operation for manufacturing the vehicle, and includes various operations such as an operation for assembling the vehicle, an operation for assembling components to the vehicle, and an operation for inspecting the vehicle.

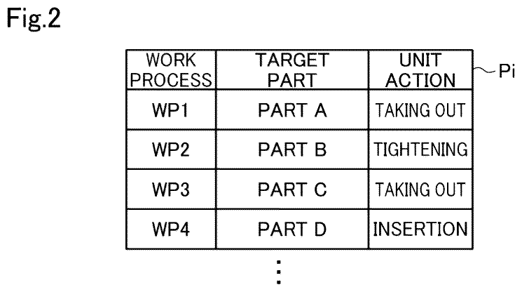

FIG. 2 is a diagram for explaining the operation in the factory FC. FIG. 2 shows the process information Pi representing each work process in the factory FC. The process information Pi is included in a bill of process (BOP) in the factory FC, for example. In FIG. 2, work processes WP1, WP2, WP3, and WP4 are shown as examples of the work processes. The work processes WP1, WP2, WP3, and WP4 are performed in this order in a time series.

As shown in FIG. 2, in the present embodiment, each work process is represented by a combination of a “target part” and a “unit action.” The “target part” means a part subject to the operation in the work process. The “unit action” means an action that does not limit an object. The unit action can also be said to represent how the target part is handled. It can be said that a combination of a “target part” and an “units action” corresponds to a combination of an object word and a verb. In the present embodiment, the types of unit actions are 10 or more, and more specifically, 15 or more.

In the present embodiment, the operation recognition system 10 recognizes the unit action shown in FIG. 2 as the type of the target operation. Therefore, for example, although the target parts are different between the work process WP1 and the work process WP3, the operation recognition system 10 recognizes the type of the target work as “taking out” regardless of whether the target work corresponds to the work process WP1 or the work process WP3. In other embodiments, the type of the target operation recognized by the operation recognition system 10 is not limited to the unit action, but may be any. For example, the type of the operation may be an action in a category higher than the unit action, that is, an action having a larger unit than the unit action, or may be an action in a category lower than the unit action, that is, an action having a smaller unit than the unit action. The number of such categories of actions may be any. The type of the target operation may correspond to the work process shown in FIG. 2, that is, represent a combination of a target part and a unit action. The size of the category of the target part and the number of the categories of the target part may be any.

In the present embodiment, the operation recognition system 10 is used to recognize the operation performed by WK in real time. That is, the “target operation” in the present embodiment corresponds to the present operation. In other embodiments, the operation recognition system 10 may be used to recognize the target operation retrospectively.

The operation recognition system 10 comprises a sensor group 60 including one or more sensors 50 and an operation recognition device 100.

The sensor 50 observes the operation by the worker WK. The expression “to observe the operation by the sensor 50” means to observe, regarding the operation to be observed, at least one of a worker WK of the operation, an operation object of the operation, an equipment EQ used for the operation, a tool TL used for the operation, and a work environment in which the operation is performed. Information obtained by observing the target operation by the sensor 50 is also referred to as observation information. The sensor 50 transmits to the operation recognition device 100 the observation information obtained by the sensor 50, that is, the detection result obtained by the sensor 50. The observation information is associated with the timing information representing timing in which the observation information has been detected.

The sensor 50 includes various sensors, such as a camera 51, a microphone 52, an inertial measurement unit (IMU) 53, a bending sensor 54, a vibration sensor 55, a vital sign sensor 56, an area sensor, and a pressure sensor. The sensor 50 is provided, for example, at various locations in the factory FC, on the equipment EQ used for the operation, on the tool TL used for the operation, and on a wearable article worn by the worker WK. The wearable article may include, for example, goggles, workwear WW, and a glove WG. As the sensor 50, in each location of the factory FC, for example, a camera 51 and/or an area sensor may be provided. Goggles worn by the worker WK may be provided with, for example, a camera 51 as a first-person camera and a microphone 52 for detecting sounds around the worker WK. Workwear WW may be provided with, for example, an IMU 53 for detecting acceleration and angular velocity generated in the worker WK. Gloves WG may be provided with, for example, an IMU 53 for detecting acceleration and angular velocity generated in hands and arms of the worker WK, a bending sensor 54 for detecting bending of fingers and wrists of the worker WK, a vibration sensor 55 for detecting vibrations associated with the operation, a pressure sensor for detecting pressure generated in the fingers with the operation, a sound detection sensor for detecting sounds associated with the operation, and a vital sign sensor 56 for detecting vital signs such as heart rate, blood pressure, and body temperature of the worker WK. The types and combinations of the sensors 50 are not limited to the above.

The operation recognition device 100 is configured as a computer with a processor 101, a memory 102 including ROM and RAM, an input/output interface 103, and an internal bus 104. The processor 101, the memory 102, and the input/output interface 103 are connected to be able to communicate in both directions via the internal bus 104. The input/output interface 103 is connected to a communication device 105 and a display device 106. The communication device 105 may be in direct or indirect communication with the sensor 50 via wired or radio communication. The display device 106 is configured by, for example, a liquid crystal display or the like, and displays various information such as information on an operation recognition result by the operation recognition system 10. The memory 102 stores a program PG1, a first model 210, a second model 220 and historical data HD. The processor 101 implements various functions, including functions as an acquisition unit 110 and an operation identification unit 120, by executing a program PG1.

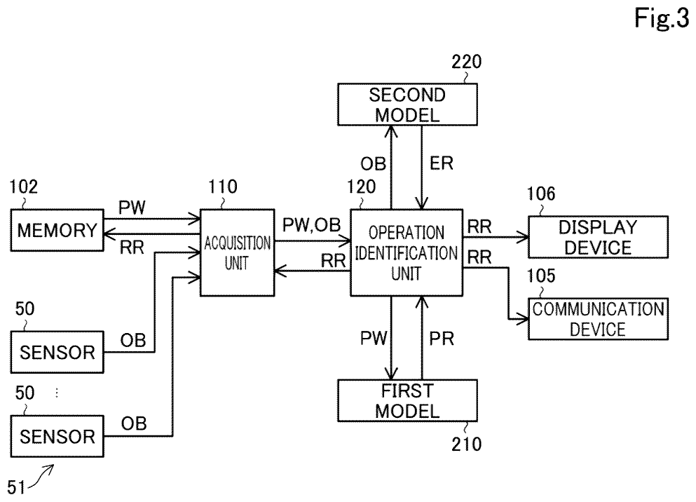

FIG. 3 is a conceptual diagram illustrating a flow of the operation recognition in the present embodiment. As shown in FIG. 3, the acquisition unit 110 acquires the observation information OB from the sensor 50. In addition, the acquisition unit 110 acquires the previous operation information PW representing the type of the operation before the target operation. In the present embodiment, the acquisition unit 110 acquires the previous operation information PW by referring to the historical data HD stored in the memory 102 as shown in FIG. 1. Details of the historical data HD will be described later.

The description will return to FIG. 3. The previous operation information PW includes information indicating at least a type of an operation immediately before the target operation. In the present embodiment, the previous operation information PW includes information indicating types of two or more consecutive operations before the target operation. Hereinafter, the number of types of operations included in the previous operation information PW is also referred to as the number N. For example, when the number N is 2, the previous operation information PW includes information indicating a type of an operation immediately before the target operation and information indicating a type of an operation one before the operation immediately before the target operation. In the present embodiment, the value of the number N is 2 or more. It should be noted that, when the operation immediately before the target operation and/or the operation one before the operation immediately before the target operation does not exist, the previous operation information PW includes information indicating that such operations do not exist.

The operation identification unit 120 executes an operation identification process. The operation identification process is a process of identifying the type of the target operation using the first model 210 and the second model 220.

The first model 210 is a machine-learning model being pre-trained on order information. The order information is information related to an order in which a plurality of operations are performed in the workshop. That is, the order information is information related to an operation order of a plurality of operations. As the order information, for example, the above-described process information Pi and/or the BOP can be used. For training of the first model 210, a plurality of types of order information may be used. In this case, in each order information, specifications and/or types of vehicles to be manufactured may be different. For each order information, the factory FC where the order information is used may be different. Thus, the generalization performance of the first model 210 can be further improved.

The first model 210 is configured as a context-based prediction model that predicts, contextually, a type of a next operation from a type of a previous operation based on the operation order. More specifically, the first model 210 is configured to output a prediction result PR related to a type of a next operation, with information indicating a type of a previous operation as an input. Here, the “previous operation” means an operation before the “next operation” and includes at least an operation immediately before the next operation. The number of operations included in the “previous operation” is the same as the number N. That is, in the present embodiment, the first model 210 is configured to be capable of predicting a type of a next operation from types of two or more consecutive previous operations. In the present exemplary embodiment, the type of the operation predicted by the first model 210 corresponds to the above-described “unit action.” As shown in FIG. 3, in the operation identification process, the operation identification unit 120 causes the first model 210 to output the prediction result PR related to the type of the target operation by inputting the previous operation information PW to the first model 210. At this time, the target operation corresponds to the next work.

In the present embodiment, as the first model 210, a machine learning model using a neural network is used. The neural network includes a convolutional neural network (CNN) and a recurrent neural network (RNN). In the present embodiment, the first model 210 has been trained by supervised learning using the order information. In the supervised learning of the first model 210, each operation represented by the order information is used as the “previous operation” and the “next operation.” In the supervised learning of the first model 210, the “previous operation” corresponds to an explanatory variable, and the “next operation” corresponds to an objective variable, that is, a label. Such supervised learning can be simply performed, for example, by sequentially referring to the order information according to time series with a sliding window. At this time, a window width of the sliding window is set based on the number N.

In other embodiments, for example, various machine learning models may be used as the first model 210 such as a random forest and support vector machine (SVM). In other embodiments, the learning method of the first model 210 is not limited to supervised learning. For example, the first model 210 may have been trained by unsupervised learning or reinforcement learning.

In the present embodiment, the first model 210 is configured to output, as a prediction result PR, first type information representing types of a plurality of predetermined operations and information representing a match probability for each type of each operation represented by the first type information. The match probability for an operation represents a probability that a type of the operation matches a type of the target operation. The match probability may be zero or a probability corresponding to 100%. As a result of the configuration of the first model 210 as described above, in the present embodiment, the prediction result PR includes predicted type information and predicted probability information. The predicted type information represents a plurality of types of predicted types. The predicted type represents a type of an operation predicted as a type of the target operation by the first model 210. In the present embodiment, the “type predicted as the type of the target operation” means a type in which the matching probability is greater than zero among the types represented by the first type information. In other embodiments, the “type predicted as the type of the target operation” may be, for example, a type among the types represented by the first type information that has a match probability equal to or greater than a predetermined threshold greater than zero. The predicted probability information represents a predicted probability for each predicted type. The prediction probability represents a probability that the predicted type matches the type of the target operation. Such a first model 210 is configured, for example, as a logistic regression model having units of a plurality of output layers. The number of units of the output layer of the first model 210 is set, for example, based on the number of types of target operations desired to be recognized.

The second model 220 is a machine learning model that has been trained to estimate the type of the target operation from the observation information OB. More specifically, the second model 220 is configured to output an estimation result ER related to the type of the target operation by using the observation information OB as input. As shown in FIG. 3, in the operation identification process, the operation identification unit 120 causes the second model 220 to output the estimation result ER by inputting the observation information OB to the second model 220.

In the present embodiment, as the second model 220, similarly to the first model 210, a machine learning model using a neural network is used. In the present embodiment, the second model 220 has been trained by supervised learning using order information. In the supervised learning of the second model 220, the observation information obtained by observing the target operation with the sensor 50 is used as an explanatory variable, and a type of the target operation is used as an objective variable, that is, a label. In other embodiments, as the second model 220, various other machine learning models may be used similarly to the first model 210. The learning method of the second model 220 is not limited to supervised learning.

In the present embodiment, the second model 220 is configured to output, as the estimation result ER, second type information representing types of a plurality of predetermined operations and information representing a match probability for each operation type represented by the second type information. As a result of configuring the second model 220 in this manner, the estimation result ER includes estimated type information and estimated probability information in the present embodiment. The estimated type information represents a plurality of estimated types. The estimated type represents a type of an operation that is estimated as the type of the target operation by the second model 220. In the present embodiment, the “type estimated as the type of the target operation” means a type in which the match probability is greater than zero among types represented by the second type information. In other embodiments, the “type estimated as the type of the target operation” may be, for example, a type among the types represented by the second type information that has a match probability equal to or greater than a predetermined threshold greater than zero. The estimated probability information represents the estimated probability for each estimated type. The estimated probability represents a probability that the estimated type matches the type of the target operation.

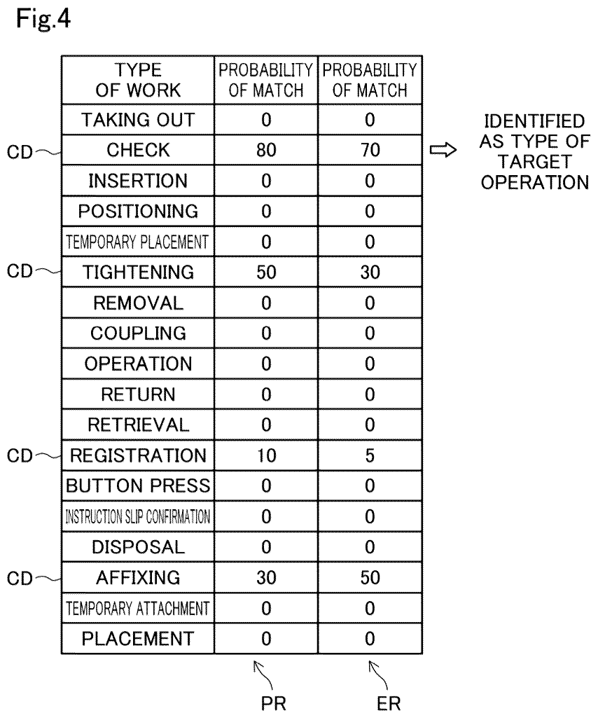

FIG. 4 is a diagram illustrating the operation identification process in the present embodiment. In the operation identification process in the present embodiment, the operation identification unit 120 determines candidates CD of a plurality of target operations by using one set of two information sets including a set of predicted type information and prediction probability information, and a set of estimated type information and estimation probability information, and identifies a type of the target operation from among the candidates CD by using the other set of the two information sets without using the one set. More specifically, in the operation identification process in the present embodiment, the operation identification unit 120 determines candidates CD of a plurality of types of target operations by using predicted type information and prediction probability information included in the prediction result PR by the first model 210. Then, the operation identification unit 120 identifies, as the type of the target operation, the type of the operation having the highest estimation probability among the determined candidates CD. That is, in the present embodiment, the predicted type information and the prediction probability information correspond to “one set” in the present disclosure, and the estimated type information and the estimation probability information correspond to “the other set” in the present disclosure. In the present embodiment, it can be said that, in narrowing down the type of the target operation from the candidates CD, only the estimation result ER is used without reusing the prediction result PR.

In the example of FIG. 4, the operation identification unit 120 determines “check,” “tightening,” “registration,” and “affixing” as candidates CD by using predicted type information and predicted probability information included in the prediction result PR. In determining the candidates CD, for example, types in a predetermined number in order of high prediction probability may be determined as the candidates CD, types having a prediction probability equal to or greater than a predetermined probability threshold may be determined as the candidates CD, or the candidates CD may be determined by using both the number and the probability threshold. Next, the operation identification unit 120 identifies, as a type of the target operation, “check” having the highest estimation probability among the candidates CD by using estimated type information and estimated probability information included in the estimation result ER by the second model 220.

Return to FIG. 3 for explanation. The operation identification unit 120 records the type of the target operation identified by the operation identification process in the memory 102 as the recognition result RR of the operation. The recognition result RR, by being recorded in the memory 102 in this way, is used as the historical data HD that records a history of operation recognition by the operation recognition system 10. In addition, the operation identification unit 120 outputs the recognition result RR. More specifically, the operation identification unit 120 displays the recognition result RR on the display device 106 and/or transmits the recognition result RR to an external device through the communication device 105.

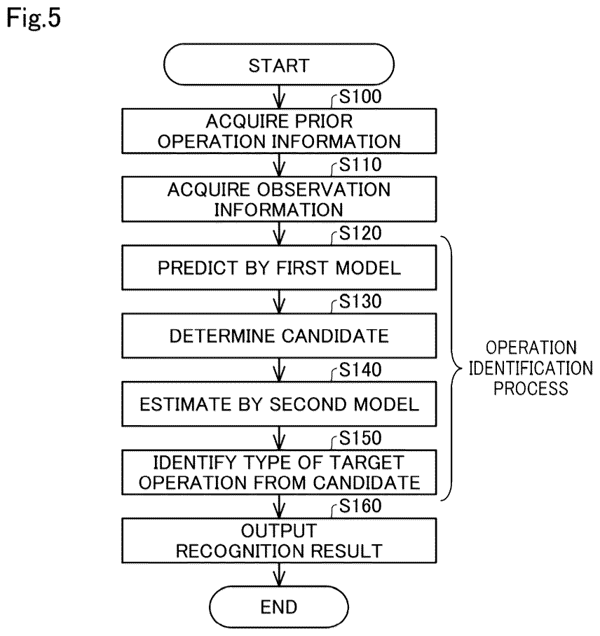

FIG. 5 is a flow chart showing processing steps of the operation recognition process for realizing the operation recognition method in the present embodiment. The operation recognition process is executed, for example, by the processor 101 of the operation recognition device 100 when a predetermined execution condition is satisfied. The execution condition may be, for example, a condition related to the observation result by the sensor 50. The condition related to the observation result is, for example, a condition that a sensor value by one or more specific sensors 50 has changed by at least a predetermined reference degree. The execution condition may be, for example, a condition related to an elapsed time. The condition related to the elapsed time is, for example, a condition that the predetermined time has elapsed from the completion timing of a previous operation recognition process.

The acquisition unit 110 acquires the previous operation information PW in step S100 in FIG. 5. In step S110, the acquisition unit 110 acquires the observation information OB obtained by the sensor 50.

Step S120 to step S150 corresponds to the operation identification process. In step S120, the operation identification unit 120 causes the first model 210 to output the prediction result PR by inputting the previous operation information PW acquired in step S100 to the first model 210. In step S130, the operation identification unit 120 determines candidates CD according to the predicted type information and the predicted probability information included in the prediction result PR output in step S120.

In step S140, the operation identification unit 120 causes the second model 220 to output the estimation result ER by inputting the observation information OB acquired in step S110 to the second model 220.

In step S150, the operation identification unit 120 identifies the type of the target operation from among the candidates CD according to the estimated type information and the estimated probability information included in the estimation result ER output in step S140. In step S150, the operation identification unit 120 records the identified type of the target operation in the memory 102 as the recognition result RR. In step S160, the operation identification unit 120 outputs the recognition result RR.

In step S150, when estimated probabilities of all types included in the candidates CD are zero, the operation identification unit 120 may, for example, terminate the operation recognition process without identifying a type of the target operation, or may identify, as the type of the target operation, the type specified in the previous time on the assumption that the previous operation is continued. In this case, the operation identification unit 120, for example, may notify a user of the operation recognition system 10 of an error via the notification device such as the display device 106 and a speaker.

According to the operation recognition system 10 in the present embodiment described above, the type of the target operation is identified by using the first model 210, which estimates the type of the target operation as the type of the next operation based on the type of the previous operation, and the second model 220, which has been trained to estimate the type of the target operation based on the observation information OB by the sensor 50. Therefore, the operation can be recognized with high accuracy considering not only the observation information OB but also the operation order. More specifically, for example, as compared with an embodiment in which operation recognition is executed using only the second model 220, in the operation recognition system 10, it is possible to suppress occurrence of a situation in which types of a plurality of operations including similar actions are confused, and operations can be recognized with high accuracy.

Further, according to the present embodiment, for example, as compared with an embodiment in which operation recognition is executed using only the second model 220, even if types or the number of sensors 50 used are reduced, it is more likely that accuracy of operation recognition can be relatively highly ensured. As a result, for example, cost reduction can be achieved. Further, by reducing types and amounts of observation information OB to be processed, it is possible to reduce processing load in operation recognition and to improve processing speed.

In the present embodiment, among the two information sets including the set of the predicted type information and the predicted probability information, and the set of the estimated type information and the estimated probability information, candidates CD of a plurality of the target operations are determined by using the one set, and the type of the target operation is identified from among the determined plurality of candidates CD by using the other set of the two information sets without using the one set. In this way, for example, as compared with an embodiment in which a type of an operation having a higher sum of the predicted probability and the estimated probability is identified as the type of the target operation, it is possible to suppress a situation in which an operation order is excessively disregarded or an actual observation result by the sensor 50 is excessively disregarded. More specifically, it is possible to suppress a type of an operation that cannot be predicted from the viewpoint of the operation order from being identified as the type of the target operation, or a type of an operation that cannot be estimated from the viewpoint of the observation information OB from being identified as the type of the target operation. Thus, according to the present embodiment, the operation can be recognized with higher accuracy by taking into balanced consideration both the operation order and the actual observation result by the sensor 50.

In the present embodiment, among the plurality of candidates CD determined by using the prediction result PR, the type of the operation having the highest estimated probability is identified as the type of the target operation. In this way, after the candidates CD are determined in consideration of the operation order, it is possible, finally, to identify, as the type of the target operation, the type of the operation that is estimated to have a high probability of being the type of the target operation from the viewpoint of the actual observation result by the sensor 50, by placing greater emphasis on the actual observation result.

In the present embodiment, the first model 210 is configured to be capable of estimating the type of the next operation from the type of two or more consecutive previous operations. The operation identification unit 120 causes the first model 210 to estimate the type of the target operation by inputting the previous operation information PW representing types of two or more consecutive operations immediately before the target operation to the first model 210. In this way, the first model 210 can predict the type of the target operation by taking into consideration not only the operation immediately before the target operation but also an operation further before, and accuracy of prediction by the first model 210 can be improved. As a result, operations can be recognized with higher accuracy.

### B. Other Embodiments

(B1) In the above-described embodiment, although the operation identification unit 120 identifies the type of the operation having the higher estimated probability among the candidates CD as the type of the target operation, the present disclosure is not limited thereto. For example, the operation identification unit 120 may identify, as the type of the target operation, the type of the operation having a higher sum of the predicted probability and the estimated probability, or may identify, as the type of the target operation, the type of the operation having a larger value obtained by adding the predicted probability and the estimated probability with different weights, respectively. The operation identification unit 120 may, for example, contrary to the above embodiment, determine candidates of types of a plurality of target operations by using the estimation result ER, and identify the type of the target operation from among the determined candidates by using the prediction result PR. In this case, the operation identification unit 120 can, for example, identify, as the type of the target operation, the type of the operation having the highest predicted probability from among the candidates determined using the estimation result ER. That is, in this case, a set of the estimated type information and the estimated probability information included in the estimation result ER correspond to “one set” in the present disclosure, and a set of the predicted type information and the predicted probability information included in the prediction result PR correspond to “the other set” in the present disclosure. The operation identification unit 120 may, for example, identify the type of the target operation by using the sum of the predicted probability and the estimated probability, or a value obtained by adding the predicted probability and the estimated probability with different weights, respectively, from among the candidates determined by using the prediction result PR or the estimation result ER.
(B2) In the above embodiment, the operation identification unit 120 causes the first model 210 to predict the type of the target operation by inputting information representing types of two or more consecutive operations before the target operation to the first model 210. In contrast, the operation identification unit 120 may, for example, cause the first model 210 to predict the type of the target operation by inputting only the information representing the type immediately before the target operation to the first model 210. That is, the previous operation information PW may include only information representing a type of an operation immediately before the target operation. In this case, the first model 210 may be configured to be capable of predicting the type of the next operation by using, as an input, only the type of the operation immediately before the next operation.
(B3) In the above embodiment, the factory FC is a vehicle manufacturing factory, but the present disclosure is not limited thereto. For example, the factory FC may be various factories such as a vehicle inspection factory, a manufacturing factory or an inspection factory of various articles different from vehicles. The operation recognition system 10 may be used not only in the factory FC but also in various workshops where the worker WK performs an operation.
(B4) In the above embodiment, a part or all of functional units such as the acquisition unit 110 and the operation identification unit 120 may be provided in an external device such as an external computer different from the operation recognition device 100.

In each of the above embodiments, a part or all of functions and processes implemented by software may be implemented by hardware. Also, a part or all of functions and processes implemented by hardware may be implemented by software. As hardware for realizing various functions in each of the above embodiments, various circuits such as integrated circuits and discrete circuits may be used.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.
(1) According to a first aspect of the present disclosure, an operation recognition device is provided. The operation recognition device comprises: an acquisition unit acquiring observation information obtained by observing a target operation with a sensor; and an operation identification unit identifying a type of the target operation using a prediction result from a first model and an estimation result from a second model, the first model being pre-trained on information related to orders in which a plurality of operations are performed and being configured to predict the type of the target operation as a next operation based on a type of a previous operation, the second model being pre-trained to estimate the type of the target operation based on the observation information.

According to this aspect, by using the first model and the second model, the operation can be recognized with high accuracy considering not only the observation information obtained by the sensor but also the order in which operations is executed.
(2) In the above aspect, the prediction result may include predicted type information and predicted probability information, the predicted type information representing a plurality of predicted operation types predicted as the type of the target operation by the first model, the predicted probability information representing a probability that each of the plurality of predicted operation types matches the type of the target operation. The estimated result may include estimated type information and estimated probability information, the estimated type information representing a plurality of estimated operation types estimated as the type of the target operation by the second model, the estimated probability information representing a probability that each of the plurality of estimated operation types matches the type of the target operation. The operation identification unit may determine a plurality of candidates of a plurality of the target operations by using one set of two information sets including a set of the predicted type information and the predicted probability information, and a set of the estimated type information and the estimated probability information. The operation identification unit may identify the type of the target operation from among the plurality of candidates by using the other set of the two information sets without using the one set.

According to this aspect, the operation can be recognized with higher accuracy by considering the order in which the operation is executed and the actual observation by the sensor in a balanced manner.
(3) In the above aspect, the operation identification unit may determine the plurality of candidates using the predicted type information and the predicted probability information, and may identify, from among the plurality of candidates, as the type of the target operation, a type of an operation having the highest probability represented in the estimated probability information by using the estimated type information and the estimated probability information.

According to this aspect, after candidates are determined in consideration of an order in which operations are executed, it is possible, finally, to identify, as the type of the target operation, the type of the operation that is estimated to have a high probability of being the type of the target operation from the viewpoint of an actual observation result by a sensor, by placing greater emphasis on the actual observation result.
(4) In the above aspect, the first model may be configured to be capable of predicting a type of the next operation based on the types of the two or more consecutive previous operations. The operation identification unit may cause the first model to predict the type of the target operation by inputting, to the first model, information representing the types of the two or more consecutive previous operations preceding the target operation.

According to this aspect, it is possible to predict the type of the target operation by taking into consideration not only an operation immediately before the target operation but also an operation further before, and accuracy of prediction by the first model can be improved. As a result, the operation can be recognized with higher accuracy.

The present disclosure can be realized not only in the form of the operation recognition device described above, but also in forms such as an operation recognition system, an operation recognition method, a program for realizing the operation recognition method, a non-transitory recording medium on which the program is recorded, and a program product. The program product may be provided, for example, as a recording medium on which the program is recorded, or as a program product deliverable via a network.

What is claimed is:

1. An operation recognition device recognizing an operation of a worker, comprising:
an acquisition unit acquiring observation information obtained by observing a target operation with a sensor; and
an operation identification unit identifying a type of the target operation using a prediction result from a first model and an estimation result from a second model, the first model being pre-trained on information related to an order which a plurality of operations are performed and being configured to predict the type of the target operation as a next operation based on a type of a previous operation, the second model being pre-trained to estimate the type of the target operation based on the observation information.

2. The operation recognition device according to claim 1, wherein
the prediction result includes predicted type information and predicted probability information, the predicted type information representing a plurality of predicted operation types predicted as the type of the target operation by the first model, the predicted probability information representing a probability that each of the plurality of predicted operation types matches the type of the target operation,
the estimated result includes estimated type information and estimated probability information, the estimated type information representing a plurality of estimated operation types estimated as the type of the target operation by the second model, the estimated probability information representing a probability that each of the plurality of estimated operation types matches the type of the target operation, and
the operation identification unit
determines a plurality of candidates of a plurality of the target operations by using one set of two information sets including a set of the predicted type information and the predicted probability information, and a set of the estimated type information and the estimated probability information, and
identifies the type of the target operation from among the plurality of candidates by using the other set of the two information sets without using the one set.

3. The operation recognition device according to claim 2, wherein
the operation identification unit
determines the plurality of candidates using the predicted type information and the predicted probability information, and
from among the plurality of candidates, identifies, as the type of the target operation, a type of an operation having the highest probability represented in the estimated probability information by using the estimated type information and the estimated probability information.

4. The operation recognition device according to claim 1, wherein
the first model is configured to be capable of predicting a type of the next operation based on the types of the two or more consecutive previous operations,
the operation identification unit causes the first model to predict the type of the target operation by inputting, to the first model, information representing the types of the two or more consecutive previous operations preceding the target operation.

5. A recognition method of recognizing an operation of a worker, comprising:
acquiring observation information obtained by observing a target operation with a sensor; and
identifying a type of the target operation using a prediction result from a first model and an estimation result from a second model, the first model being pre-trained on information related to an order in which a plurality of operations are performed and being configured to predict the type of the target operation as a next operation based on a type of a previous operation, the second model being pre-trained to estimate the type of the target operation based on the observation information.
